(19) United States
(12) Patent Application Publication
(10) Pub. No.: US 2024/0301241 A1
(43) Pub. Date: Sep. 12, 2024

(54) SILICON OXYNITRIDE REMOVAL ENHANCERS AND METHODS OF USE THEREOF

(71) Applicant: FUJIMI INCORPORATED, Aichi (JP)

(72) Inventor: Jimmy GRANSTROM, Tualatin, OR (US)

(21) Appl. No.: 18/589,690

(22) Filed: Feb. 28, 2024

Related U.S. Application Data
(60) Provisional application No. 63/449,327, filed on Mar. 2, 2023.

(51) Int. Cl. C09G 1/02

(52) U.S. Cl. CPC C09G 1/02

(57) ABSTRACT

The present disclosure relates to chemical mechanical polishing (CMP) compositions for polishing silicon oxynitride (SiON) surfaces. In particular, the CMP composition includes an abrasive, an additive, and water, combined in specified amounts to provide a composition with advantageous properties such as high SiON removal rates even upon dilution of the composition with a diluent.

### TECHNICAL FIELD

The present disclosure relates to chemical mechanical polishing (CMP) compositions comprising an abrasive, an additive, and water.

### BACKGROUND

Silicon oxynitride (SiNₓO_{y}) is an important inorganic material widely studied for its outstanding electronic and mechanical performance. SiNₓO_{y} is the intermediate phase between silicon dioxide (SiO₂) and silicon nitride (Si₃N₄), which possesses high durability at high temperature, high resistance to thermal-shock and oxidation, high density, excellent mechanical performance, and a low dielectric constant. One of the benefits of silicon oxynitride (SiNₓO_{y}) is the fact that its stoichiometry can be changed significantly, covering the entire range from silicon dioxide (SiO₂) to silicon nitride (Si₃N₄), i.e., there is no miscibility gap for these two materials. By varying the chemical composition of SiNₓO_{y}, during the fabrication process, its refractive index and dielectric constant can be tuned. SiNₓO_{y} also has adjustable thin film stress and exhibits photoluminescence (PL) in the visible light range at room temperature. Thus, SiNₓO_{y} is highly attractive in integrated circuits (IC), barrier layers, non-volatile memory, optical waveguides, organic light emitting diode (OLED), and anti-scratch coatings. In addition, it can be used in high-temperature-related applications, for example, in non-linear optics and as mechanical components, owing to its high strength, thermal insulation, and electronic and chemical resistance.

Silicon oxynitride (SiNₓO_{y}) is applied as a thin film using plasma chemical vapor deposition (CVD) or low pressure chemical vapor deposition (LP-CVD) to the substrate of interest and can subsequently be polished using a chemical-mechanical process (CMP). Herein, “SiNₓO_{y}” is also referred to as “SiON”.

CMP is a process in which material is removed from a surface of a substrate (such as a semiconductor wafer) and the surface is polished (planarized) by coupling a physical process, such as abrasion, with a chemical process, such as oxidation or chelation. In its most rudimentary form, CMP involves applying a slurry to the surface of the substrate or a polishing pad that polishes the substrate. This process achieves both the removal of unwanted material and planarization of the surface of the substrate. It is not desirable for the removal or polishing process to be purely physical or purely chemical, but rather comprise a synergistic combination of both.

Many of the currently known CMP slurry compositions for polishing SiON-containing surfaces are suitable for only a limited number of purposes, as many polishing slurries tend to produce poor film removal rate, which leads to poor manufacturing yields.

Thus, there is a continuous need to develop and improve CMP slurry compositions with better polishing properties and/or polishing performance.

### SUMMARY

In accordance with the purpose(s) of the currently disclosed subject matter or problems to be solved by the invention, as embodied and broadly described herein, it is an object of the present invention to provide a composition for polishing substrates, such as those containing silicon oxynitride (SiON), that facilitate improvement in polishing speeds when using CMP. Another object of the present invention is to provide a method for removal of a material from a substrate, such as SiON.

Accordingly, the subject matter of the present disclosure in one aspect relates to a polishing composition comprising an abrasive, an additive, and water, wherein
the abrasive contains colloidal silica and the additive contains an aminoalkyl alcohol, when the aminoalkyl alcohol is tertiary amine, a hydroxyl group-substituted alkyl group bonded to nitrogen atom is linear, and the polishing composition has a pH of about 2.5 or less.

Another aspect relates to a polishing composition comprising an abrasive, an additive, and water, wherein the abrasive includes colloidal silica, the additive includes an aminoalkyl alcohol, the aminoalkyl alcohol is represented by N (R¹) (R²) (R³), and R¹, R², and R³ are each independently selected from hydrogen atom and an alkyl group optionally substituted with a hydroxyl group, i) at least one of R¹, R², and R³ is the alkyl group substituted with one or more hydroxyl groups, and ii) at least one of R¹, R², and R³ is an unsubstituted alkyl group, or at least two of R¹, R², and R³ are hydrogen atoms, when the alkyl group substituted with the hydroxyl group includes quaternary carbon, the alkyl group substituted with the hydroxyl group contains two or more hydroxyl groups, and the polishing composition has a pH of about 2.5 or less.

In another aspect, the subject matter described herein relates to a method of polishing a substrate, and relates to a method of producing a polished substrate comprising the steps of: 1) providing a polishing composition as disclosed herein; 2) providing a substrate, wherein the substrate comprises a SiON-containing layer; and 3) polishing the substrate with the polishing composition.

### DETAILED DESCRIPTION

The present invention can be understood more readily by reference to the following detailed description of the invention and the examples included therein.

Before the present compounds, compositions, articles, systems, devices, and/or methods are disclosed and described, it is to be understood that they are not limited to specific synthetic methods unless otherwise specified, or to particular components unless otherwise specified, as such may, of course, vary. It is also to be understood that the terminology used herein is for describing particular aspects only, and is not intended to be limiting. Although, any methods and materials that are similar or equivalent to those described herein can be used in the practice or testing of the present invention, example methods and materials are now described.

Described herein are polishing compositions comprising an abrasive, an additive, and water. These polishing compositions are intended for polishing a substrate where the polishing compositions exhibit a SiON removal rate of at least 250 Å/min.

Furthermore, it was surprising and unexpected to discover that these polishing compositions are able to maintain a SiON removal rate of greater than 250 Å/min even upon various fold of dilution with a diluent (such as water). Thus, the polishing compositions disclosed herein are capable of polishing composition that exhibit an SiON removal rate of greater than 250 Å/min, even when diluted, thereby providing additional benefits such as reduced manufacturing cost.

The polishing compositions described herein have uses such as, but not limited to, the CMP of SiON-containing substrates and are discussed in more detail below.

### A. Definitions

Listed below are definitions of various terms used to describe this invention. These definitions apply to the terms as they are used throughout this specification, unless otherwise limited in specific instances, either individually or as part of a larger group.

As used herein, the term “average primary particle size” refers to a particle size that can be measured by image observation of the particles, as typified, for example, by electron microscopy.

As used herein, the term “average mean particle size” refers to a particle size that can be measured, for example, by dynamic light scattering, as typified by the laser diffraction scattering method.

As used in the specification and the appended claims, the singular forms “a,” “an” and “the” include plural referents unless the context clearly dictates otherwise. Thus, for example, reference to “an abrasive” or “a pH-adjusting agent” includes mixtures of two or more such abrasives or pH-adjusting agents.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It will also be understood that there are a number of values disclosed herein, and that each value is herein disclosed as “about” that particular value in addition to the value itself. For example, if the value “10” is disclosed, then “about 10” is also disclosed. It will also be understood that each unit between two particular units is also disclosed. For example, if 10 and 15 are disclosed, then 11, 12, 13, and 14 are also disclosed. Herein, about X (X is a numerical value) may further include ±10% or ±5% of X, and specifically means X×0.9 to X×1.1. Further, about X may be X itself.

References in the specification and concluding claims to parts by weight of a particular element or component in a composition denote the weight relationship between the element or component and any other elements or components in the composition or article for which a part by weight is expressed. Thus, in a compound containing 2 parts by weight of component “X” and 5 parts by weight of component “Y,” “X and Y” are present at a weight ratio of 2:5, and are present in such ratio regardless of whether additional components are contained in the compositions.

A weight percent (wt %) of a component, unless specifically stated to the contrary, is based on the total weight of the vehicle or composition in which the component is included.

As used herein, the terms “optional” and “optionally” mean that the subsequently described event or circumstance can or cannot occur, and that the description includes instances where said event or circumstance occurs and instances where it does not.

Herein, “X to Y” is used to mean that numerical values (X and Y) described before and after “to” are included as a lower limit value and an upper limit value, and means “X or more and Y or less”. In a case where a plurality of “X to Y” are described, for example, in a case where “X1 to Y1, or X2 to Y2” is described, a disclosure in which each numerical value is an upper limit, a disclosure in which each numerical value is a lower limit, and a combination of the upper limit and the lower limit are all disclosed (that is, it is a legitimate basis for the amendment.). Specifically, all of the correction of X1 or more, the correction of Y2 or less, the correction of X1 or less, the correction of Y2 or more, the correction of X1 to X2, the correction of X1 to Y2, and the like must be regarded as legitimate. In addition, unless otherwise specified, operations and measurements of physical properties and the like are performed under the conditions of room temperature (20 to 25° C.)/relative humidity 40 to 50% RH. The concentration described herein may be a concentration in POU (point of use) or a concentration before dilution to the concentration of POU. The dilution fold may be 2 to 10-fold.

### B. Polishing Composition

The fundamental mechanism of CMP is to soften a surface layer by chemical reaction and then remove the softened layer by mechanical force with abrasive particles.

In polishing compositions for use with SiON-containing substrates, one key performance metric is a high SiON removal rate.

In the present invention, in particular, included in a composition is an aminoalkyl alcohol, which when combined with the abrasive provides a composition with advantageous properties, such as high silicon oxynitride (SiON) removal rates. As a result, compositions well suited for polishing a silicon oxynitride surface can be provided.

It was therefore surprising and unexpected to discover that the polishing compositions disclosed herein are able to achieve SiON rates of greater than 250 Å/min, which contain an abrasive, the specific additive having particular aminoalkyl alcohol, and water. High removal rates were obtained when the aminoalkyl alcohol exhibited certain structural features related to the number of carbon, oxygen, and nitrogen atoms. Such structural features are discuss in more detail below. In addition, it was surprising and unexpected to discover that the pH of the polishing compositions disclosed herein had to exhibit a certain degree of acidity in order to maintain SiON rates of greater than 250 Å/min.

As described herein, the combination of these specific components and/or features is key to obtaining these desired properties.

### 1. Abrasive

The polishing composition described herein contains an abrasive. The abrasive is typically a metal oxide abrasive preferably selected from the group consisting of silica, alumina, titania, zirconia, germania, ceria, and mixtures thereof. In some embodiments, the abrasive is silica. In a further embodiment, the abrasive is colloidal silica. In some embodiments, the abrasive does not include a metal oxide abrasive selected from the group consisting of alumina, titania, zirconia, germania, ceria, and mixtures thereof.

In some embodiments, the abrasive is either a commercial product or a synthetic product. As a method for producing colloidal silica, for example, a sodium silicate method and a sol-gel method can be exemplified, and colloidal silica produced by either method can be used preferably as the abrasive of the present invention. However, in the light of reducing metal impurities, colloidal silica produced by the sol-gel method, which can produce colloidal silica at high purity, is more preferable.

The abrasive can have any suitable particle size. In some embodiments, the grains of the abrasives used in the present invention have an average primary particle size of 10 nm or more and 100 nm or less. In some embodiments, the grains of the abrasives used in the present invention have an average primary particles size of from about 10 nm to about 100 nm, from about 10 nm to about 75 nm, from about 10 nm to about 65 nm, from about 10 nm to about 55 nm, from about 10 nm to about 45 nm, from about 10 nm to about 40 nm, from about 10 nm to about 37 nm, from about 12 nm to about 37 nm, or from about 12 nm to 35 nm. In some embodiments, the grains of the abrasives used in the present invention have an average primary particles size of from about 10 nm to about 50 nm, from about 10 nm to about 40 nm, from about 15 nm to about 40 nm, from about 20 nm to about 40 nm, from about 25 nm to about 40 nm, from about 30 nm to about 40 nm, from about 32 nm to about 38 nm, or from about 34 nm to about 36 nm. In some embodiments, the grains of the abrasives used in the present invention have an average primary particles size of from about 10 nm to about 42 nm, from about 10 nm to about 38 nm, from about 10 nm to about 36 nm, from about 10 nm to about 32 nm, from about 10 nm to about 20 nm, from about 10 nm to about 18 nm, from about 10 nm to about 16 nm, from about 10 nm to about 14 nm, or from about 11 nm to about 13 nm.

A lower limit of the average primary particle size of the abrasive grains is preferably 10 nm or more, is more preferably 12 nm or more, 20 nm or more, 25 nm or more, and is further preferably 30 nm or more. Further, an upper limit of the average primary particle size of the abrasive grains is preferably less than 40 nm, is more preferably 37 nm or less, and is further preferably 35 nm or less. Incidentally, the average primary particle sizes of the abrasive grains may be measured using any suitable method known in the art (e.g., transmission electron microscopy, scanning electron microscopy, or by STEM, such as by using a Hitachi High-Tech HD-2700 Scanning Transmission Electron Microscope).

The grains of the abrasive can have any suitable mean particle size. For example, the grains of the abrasive can have an average mean particle size of from about 10 nm to about 100 nm, from about 15 nm to about 85 nm, from about 18 nm to about 80 nm, from about 20 nm to about 80 nm, from about 20 nm to about 75 nm, or from about 20 nm to about 70 nm. In some embodiments, the grains of the abrasive can have an average mean particle size of from about 1 nm to about 100 nm, from about 5 nm to about 75 nm, from about 10 nm to about 75 nm, from about 10 nm to about 70 nm, from about 10 nm to about 50 nm, from about 10 nm to about 30 nm, from about 15 nm to about 25 nm, from about 17 nm to about 23 nm, or from about 19 nm to about 22 nm. In some embodiments, the grains of the abrasive can have an average mean particle size of from about 20 nm to about 120 nm, from about 30 nm to about 100 nm, from about 40 nm to about 80 nm, from about 50 nm to about 80 nm, from about 60 nm to about 80 nm, from about 65 nm to about 75 nm, from about 68 nm to about 73 nm, or from about 70 nm to about 73 nm. Incidentally, the average mean particle size may be measured using any suitable method known in the art (e.g., by light scattering, such as by using a Malvern Panalytical ZetaSizer Nano light scattering system).

The abrasive can have any suitable surface area per weight. For example, the abrasive can have an average BET surface area of about 40 m²/g or more, about 60 m²/g or more, about 80 m²/g or more, about 100 m²/g or more, about 120 m²/g or more, about 140 m²/g or more, about 160 m²/g or more, about 180 m²/g or more, or about 200 m²/g or more. Alternatively, or in addition, the abrasive can have an average surface area of about 300 m²/g or less, about 270 m²/g or less, about 250 m²/g or less, about 200 m²/g or less, about 180 m²/g or less, about 150 m²/g or less, about 120 m²/g or less, about 100 m²/g or less, more, or about 90 m²/g or less. In some embodiments, the abrasive can have an average surface area in a range from about 30 m²/g to about 150 m²/g, from about 40 m²/g to about 140 m²/g, from about 50 m²/g about 130 m²/g, from about 55 m²/g to about 120 m²/g, from about 60 m²/g to about 110 m²/g, from about 65 m²/g to about 100 m²/g, from about 70 m²/g to about 90 m²/g. In some embodiments, the abrasive can have an average surface area in a range from about 100 m²/g to about 300 m²/g, from about 120 m²/g to about 290 m²/g, from about 140 m²/g about 280 m²/g, from about 160 m²/g to about 270 m²/g, from about 180 m²/g to about 260 m²/g, from about 190 m²/g to about 250 m²/g, from about 200 m²/g to about 240 m²/g.

The silanol group density on the silica surface of the abrasive can vary. The unit of the silanol group density (also referred to as silanol density) is “number/nm²”, but this may be simply referred to as “nm⁻²”. In some embodiments, the average silanol group density on the silica surface of the abrasive grains contained in the polishing composition of the present invention is 6.5 nm⁻² or less. If the average silanol group density is more than 6.5 nm⁻², hardness of the abrasive grains is low, and the polishing speed is accordingly lowered.

The average silanol group density on the surface of the abrasive grains is preferably 6.2 nm⁻² or less, and is more preferably 6.0 nm⁻² or less.

In some embodiments, the average silanol group density on the surface of the abrasive grains is from about 1 nm⁻² to about 6.5 nm⁻², from about 1.5 nm⁻² to about 6.5 nm⁻², from about 2.0 nm⁻² to about 6.5 nm⁻², from about 3.0 nm⁻² to about 6.5 nm⁻², from about 4.0 nm⁻² to about 6.5 nm⁻², from about 5.0 nm⁻² to about 6.5 nm⁻², from about 5.5 nm⁻² to about 6.5 nm⁻², from about 5.6 nm⁻² to about 6.4 nm⁻², about 5.7 nm⁻² to about 6.3 nm⁻², or about 5.8 nm⁻² to about 6.2 nm⁻².

In some embodiments, the average silanol group density on the surface of the abrasive grains is about 2.0 nm⁻² or more, about 2.5 nm⁻² or more, about 3.0 nm⁻² or more, about 3.5 nm⁻² or more, about 4.0 nm⁻² or more, about 4.5 nm⁻² or more, about 5.0 nm⁻² or more, about 5.5 nm⁻² or more, or about 5.8 nm⁻² or more. Within this range, a useful polishing speed can be obtained. In some embodiments, the average silanol group density on the surface of the abrasive grains is 6.5 nm⁻² or less, 6.4 nm⁻² or less, 6.3 nm⁻² or less, 6.2 nm⁻² or less, 6.1 nm⁻² or less, 6.0 nm⁻² or less, 5.9 nm⁻² or less, or 5.8 nm⁻² or less.

In some embodiments, the average silanol group density on the surface of the abrasive grains is from about 5 nm⁻² to about 6.5 nm⁻², from about 5.5 nm⁻² to about 6.5 nm⁻², from about 5.5 nm⁻² to about 6.3 nm⁻², from about 5.5 nm⁻² to about 6.2 nm⁻², from about 5.6 nm⁻² to about 6.0 nm⁻², or from about 5.7 nm⁻² to about 6.0 nm⁻².

In some embodiments, the average silanol group density on the surface of the abrasive grains is from about 5.7 nm⁻² to about 6.5 nm⁻², from about 5.8 nm⁻² to about 6.5 nm⁻², from about 5.9 nm⁻² to about 6.4 nm⁻², or about 6.0 nm⁻² to about 6.3 nm⁻².

Incidentally, a lower limit of the average silanol group density is generally 0.

The number of silanol groups per unit surface area of the abrasive grains can be calculated by the Sears method using neutralization titration described in Analytical Chemistry, vol. 28, No. 12, 1956, 1982 to 1983 by G. W. Sears. The calculation formula for the number of silanol groups is calculated by the following equation.

$$ρ = ( c \times a \times {N}_{A} ) / ( C \times S )$$

ρ: Number of silanol groups [count/nm²]
c: Concentration of sodium hydrate solution used in titration [mol/L]
a: Amount of sodium hydrate solution required to change pH from 4 to 9 added dropwise [mL]
N_{A}: Avogadro's number (6.022×10²³ [count/mol])
C: Mass of silica [g]
S: BET specific surface area [nm⁻²/g]

The number of silanol groups per unit surface area of the abrasive grains can be controlled by selection of the method for producing abrasive grains, or the like.

Moreover, the abrasive grains may be surface-modified as long as the average silanol group density is within the above-described range. In particular, organic acid immobilized onto colloidal silica is preferable. Such immobilization of the organic acid to surfaces of the colloidal silica renders anionically modified colloidal silica, which is contained in the disclosed polishing composition. Typically, immobilization is achieved by chemically bonding functional groups of the organic acid with the surfaces of the colloidal silica. The organic acid is not immobilized to the colloidal silica by merely allowing the colloidal silica and the organic acid to coexist and/or associate with one another but do in fact require a physical bond. For example, sulfonic acid is a type of organic acid that can be immobilized onto colloidal silica, as is described in “Sulfonic acid-functionalized silica through quantitative oxidation of thiol groups”, Chem. Commun. 246-247 (2003), and can be adopted more specifically by coupling a silane coupling agent having thiol groups such as 3-mercaptopropyltrimethoxysilane with the colloidal silica and subsequently oxidizing the thiol groups with hydrogen peroxide. Only then can the sulfonic acid be immobilized onto the surface of colloidal silica. Alternatively, if carboxylic acid is immobilized onto the surface of colloidal silica, for example, such methods are described in “Novel Silane Coupling Agents Containing a Photolabile 2-Nitrobenzyl Ester for Introduction of a Carboxy Group on the Surface of Silica Gel”, Chemistry Letters, 3, 228-229 (2000), can be adopted. More specifically, by coupling a silane coupling agent containing photolabile 2-nitrobenzyl ester with the colloidal silica and subsequently irradiating the colloidal silica with light, the carboxylic acid is immobilized onto the surface of the colloidal silica.

The amount of abrasive present in the disclosed polishing composition can vary. In some embodiments, the amount of abrasive in the polishing composition is about 0.1 wt % or more, about 0.5 wt % or more, about 1.0 wt % or more, about 2.0 wt % or more, about 3.0 wt % or more, about 4.0 wt % or more, about 5.0 wt % or more, about 6.0 wt % or more, or about 7 wt % or more, but no more than 10 wt %, based on the total weight of the polishing composition. Alternatively, or in addition, the amount of abrasive in the polishing composition can be about 9 wt % or less, about 8.5 wt % or less, about 8 wt % or less, about 7 wt % or less, about 6 wt % or less, about 5 wt % or less, about 4 wt % or less, about 3 wt % or less, but no less than about 2 wt %, based on the total weight of the polishing composition. In some embodiments, the amount of abrasive in the polishing composition is greater than 2 wt %, greater than 3 wt %, greater than 4 wt %, greater than 5 wt %, greater than 6 wt %, or greater than 6.5 wt %, based on the total weight of the polishing composition.

In some embodiments, the amount of abrasive in the polishing composition can be in a range from about 1 wt % to about 10 wt %, about 2 wt % to about 8.0 wt %, about 4 wt % to about 8.0 wt %, or from about 4 wt % to about 6 wt %, based on the total weight of the polishing composition. In some embodiments, the amount of abrasive in the polishing composition can be in a range from about 3 wt % to about 6.0 wt %, from about 3 wt % to about 5 wt %, 3.5 wt % to about 4.5 wt %, or from about 3.75 wt % to about 4.25 wt %, based on the total weight of the polishing composition. In some embodiments, the amount of abrasive in the polishing composition is about 4.0 wt %, based on the total weight of the polishing composition.

In some embodiments, the amount of abrasive in the polishing composition can be in a range from about 5 wt % to about 10 wt %, from about 6 wt % to about 9.0 wt %, from about 7 wt % to about 9 wt %, from about 7.5 wt % to about 8.5 wt %, or from about 7.75 wt % to about 8.25 wt %, based on the total weight of the polishing composition. In some embodiments, the amount of abrasive in the polishing composition is about 8.0 wt %, based on the total weight of the polishing composition.

In some embodiments, the amount of abrasive has an effect on the properties of the polishing composition, such as the removal rate of silicon oxynitride (SiON). In an embodiment, the amount of abrasive is from about 4.0 wt % to about 8.0 wt % based on the total weight of the polishing composition.

While the abrasive can be of any reasonable size, the size of the abrasive influences the smoothness of the finish obtained. Precision polishing operations materials, such as optical components, plastics, metals, gemstones, semiconductor components, and the like, typically involve the use of abrasives with smaller sizes. For example, compositions for use in connection with precision polishing involve suspensions of abrasives with smaller average particle sizes.

In an embodiment the abrasive is colloidal silica. In some embodiments, the abrasive substantially comprises colloidal silica. As used herein, “substantially” means that 95% by weight or more, preferably 98% by weight or more, or more preferably 99% by weight or more of the particles constituting the abrasive are colloidal silica, and it includes that 100% by weight of the particles are colloidal silica. The surface of the colloidal silica is preferably modified with organic acid (for example, sulfonic acid).

The abrasive is suspended in the compositions disclosed herein and is colloidally stable. The term colloid refers to the suspension of abrasive particles in the liquid carrier. Colloidal stability refers to the maintenance of the suspension over time. In some embodiments, the suspension is stable for at least 1, 2, 3, 4, 5, 6, or 7 days. In some embodiments, the suspension is stable for at least 1 week, at least 2 weeks, at least 3 weeks, or at least 4 weeks.

In the context of this invention, an abrasive suspension is considered colloidally stable if, when the silica is placed into a 100-mL graduated cylinder and allowed to stand without agitation for a time of two hours, the value obtained by dividing the difference between the concentration of particles in the bottom 50 mL of the graduated cylinder ([B] in terms of g/mL) and the concentration of particles in the top 50 mL of the graduated cylinder ([T] in terms of g/mL) by the total concentration of particles in the abrasive composition ([C] in terms of g/mL) (i.e., ([B]−[T])/[C]) is less than or equal to 0.5. The value of ([B]−[T]/[C]) desirably is less than or equal to 0.3, and preferably is less than or equal to 0.1.

### 2. Additive

The polishing composition described herein contains an additive. In some embodiments, the additive is an aminoalkyl alcohol. The number of carbon atoms present in the aminoalkyl alcohol can vary. In some embodiments, the aminoalkyl alcohol contain at least 3 carbon atoms, at least 5 carbon atoms, at least 6 carbon atoms, at least 8 carbon atoms, or at least 10 carbon atoms. In some embodiments, the aminoalkyl alcohol is selected from a (C2-C12) aminoalkyl alcohol, from a (C3-C12) aminoalkyl alcohol, from a (C4-C12) aminoalkyl alcohol, from a (C5-C10) aminoalkyl alcohol, from a (C6-C10) aminoalkyl alcohol, or from a (C8-C10) aminoalkyl alcohol. In some embodiments, at least one carbon atom of the aminoalkyl alcohol is substituted with one or more substituents (e.g., halo, —COOH, —SO₃H, —OCF₃, etc.). In some embodiments, the carbon atoms of the aminoalkyl alcohol are all unsubstituted.

The aminoalkyl alcohol has at least one hydroxyl group. In some embodiments, the aminoalkyl alcohol has one hydroxyl group. In some embodiments, the aminoalkyl alcohol has two hydroxyl groups. In some embodiments, the aminoalkyl alcohol has three hydroxyl groups. In some embodiments, the at least one hydroxyl group is a primary hydroxyl group. In some embodiments, the at least one hydroxyl group is a secondary hydroxyl group.

The aminoalkyl alcohol can contain carbon and oxygen atoms in various ratios. In some embodiments, the aminoalkyl alcohol has a carbon atom-to-oxygen atom ratio of from about 5:2 to about 10:1, from about 6:1 to about 10:1, or from about 8:1 to about 10:1. In some embodiments, the aminoalkyl alcohol has a carbon atom-to-oxygen atom ratio of from about 5:2 to about 8:1, from about 6:1 to about 8:1, or from about 5:2 to about 6:1. In some embodiments, the aminoalkyl alcohol has a carbon atom-to-oxygen atom ratio of about >2.0, about >2.5, about >3.0, about >4.0, about >5.0, about >6.0, about >7.0, about >8.0, or is about >9.0.

The aminoalkyl alcohol has at least one nitrogen atom. In some embodiments, the aminoalkyl alcohol has one nitrogen atom. In some embodiments, the nitrogen atom present in the aminoalkyl alcohol is an amino group. In some embodiments, the amino group is a primary amino group, a secondary amino group, or a tertiary amino group.

The aminoalkyl alcohol can contain carbon and nitrogen atoms at various ratios. In some embodiments, the aminoalkyl alcohol has a carbon atom-to-nitrogen atom ratio of from about 5:1 to about 10:1, from about 6:1 to about 10:1, or from about 8:1 to about 10:1. In some embodiments, the aminoalkyl alcohol has a carbon atom-to-nitrogen atom ratio of from about 5:1 to about 8:1, from about 6:1 to about 8:1, or from about 5:1 to about 6:1. In some embodiments, the aminoalkyl alcohol has a carbon atom-to-nitrogen atom ratio of about >2.0, about >3.0, about >4.0, about >5.0, about >6.0, about >7.0, about >8.0, or is about >9.0.

In some embodiments, the carbon atom-to-nitrogen or oxygen atom ratio of the aminoalkyl alcohol can vary. In some embodiments, the aminoalkyl alcohol has a carbon atom-to-nitrogen atom or oxygen ratio of about >1.0, about >2.0, about >3.0, about >4.0, about >5.0, about >6.0, about >7.0, about >8.0, or is about >9.0.

In some embodiments, the carbon atom-to-nitrogen or oxygen atom ratio is about 20 or less, about 19 or less, about 18 or less, about 17 or less, about 16 or less, about 15 or less, about 14 or less, about 13 or less, about 12 or less, about 11 or less, about 10 or less, about 9 or less, or about 8 or less.

In some embodiments, the carbon atom-to-nitrogen or oxygen atom ratio of the aminoalkyl alcohol is 1 to 12, 4 to 11, 7 to 11, or 8 to 10.

In some embodiments, the aminoalkyl alcohol is represented by N (R¹) (R²) (R³), and R¹. R², and R³ are each independently selected from the hydrogen atom and the alkyl group optionally substituted with the hydroxyl group, wherein i) at least one of R¹, R², and R³ is the alkyl group substituted with one or more hydroxyl groups, and ii) at least one of R¹, R², and R³ is an unsubstituted alkyl group, or at least two of R¹, R², and R³ are hydrogen atoms. In some embodiments, the number of carbon atom in the alkyl group optionally substituted with the hydroxyl group and the number of carbon atom in the unsubstituted alkyl group are each independently 1 or more, 2 or more, 3 or more, 4 or more, 5 or more, 6 or more, 7 or more, or 8 or more. In some embodiments, the number of carbon atom in the alkyl group optionally substituted with the hydroxyl group and the unsubstituted alkyl group is 20 or less, 18 or less, 16 or less, 14 or less, 12 or less, 10 or less, or 9 or less. In some embodiments, one or two of R¹, R², and R³ is the alkyl group substituted with the hydroxyl group. In some embodiments, the alkyl group substituted with the hydroxyl group does not contain quaternary carbon. In some embodiments, the aminoalkyl alcohol does not comprise the quaternary carbon. In some embodiments, one or two of R¹, R², and R³ comprises a secondary hydroxyl group. In some embodiments, the aminoalkyl alcohol comprises the secondary hydroxyl group. In some embodiments, when the alkyl group substituted with the hydroxyl group contains the quaternary carbon, the alkyl group substituted with the hydroxyl group contains two or more hydroxyl groups. In some embodiments, at least one of R¹, R², and R³ is the alkyl group having 6 or more carbon atoms which may be substituted with the hydroxyl group. In some embodiments, the aminoalkyl alcohol is primary amine and has the secondary hydroxyl group. In some embodiments, the aminoalkyl alcohol has 5 or more or 6 or more carbon atoms and 12 or less or 10 or less carbon atoms. In some embodiments, the aminoalkyl alcohol is secondary amine and has the unsubstituted alkyl group having 6 or more carbon atoms. In some embodiments, the aminoalkyl alcohol has the alkyl group substituted with the hydroxyl group having 1 to 4 carbon atoms. In some embodiments, when all three of R¹, R², and R³ are alkyl groups optionally substituted with the hydroxyl group, preferably one or more, more preferably two or more, and further preferably three of the alkyl groups optionally substituted with the hydroxyl group are linear. In some embodiments, when two of R¹, R², and R³ are alkyl groups optionally substituted with the hydroxyl group, preferably one or more, more preferably two of the alkyl groups optionally substituted with the hydroxyl group are linear. In some embodiments, when one of R¹, R², and R³ is the alkyl group optionally substituted with the hydroxyl group, it does not comprise the quaternary carbon. As described above, when the aminoalkyl alcohol has a simple structure such as a linear or a nearly linear (although the mechanism is a presumption and is not limited thereto), steric hindrance of the aminoalkyl alcohol can be suppressed, adsorption effect to the object to be polished can be improved, and the desired effect of the present invention can be efficiently exhibited. In some embodiments, the additive (i.e., aminoalkyl alcohol) is selected from the group consisting of 1-amino-2-octanol, 1-amino-2-propanol, 1-amino-2-butanol, 1-amino-3-octanol, 2-amino-1-octanol, 3-amino-4-octanol, 8-amino-1-octanol, 2-amino-2-ethyl-1,3-propanediol (VOX), 2-diethyl ethanolamine, and 2-(octylamino)ethanol. In some embodiments, the aminoalkyl alcohol is 3-amino-4-octanol.

The amount of additive present in the polishing composition can vary. In some embodiments, the additive is present in the polishing composition in an amount ranging from about 0.1 wt % to about 0.5 wt %, about 0.15 wt % to about 0.45 wt %, from about 0.18 wt % to about 0.40 wt %, from 0.18 wt % to about 0.36 wt %, from about 0.21 wt % to about 0.36 wt %, from about 0.24 wt % to about 0.36 wt %, or from about 0.31 wt % to about 0.36 wt %, based on the total weight of the composition.

In some embodiments, the additive is present in the polishing composition in an amount ranging from about 0.20 wt % to about 0.40 wt %, about 0.24 wt % to about 0.40 wt %, from about 0.30 wt % to about 0.40 wt %, from 0.35 wt % to about 0.40 wt %, based on the total weight of the composition.

In some embodiments, the additive is present in the polishing composition in an amount ranging from about 0.10 wt % to about 0.31 wt %, about 0.15 wt % to about 0.31 wt %, from about 0.15 wt % to about 0.25 wt %, from 0.18 wt % to about 0.25 wt %, from 0.20 wt % to about 0.25 wt %, or from 0.21 wt % to about 0.24 wt %, based on the total weight of the composition.

In some embodiments, the additive is present in the polishing composition in an amount of about 0.10 wt % or more, about 0.15 wt % or more, about 0.18 wt % or more, about 0.20 wt % or more, about 0.24 wt % or more, or 0.30 wt % or more, based on the total weight of the composition. Alternatively, or in addition, the amount of additive present in the polishing composition can be about 0.40 wt % or less, about 0.38 wt % or less, about 0.36 wt % or less, about 0.32 wt % or less, about 0.30 wt % or less, about 0.28 wt % or less, about 0.26 wt % or less, about 0.24 wt % or less, about 0.20 wt % or less, based on the total weight of the composition. Within this range, there are effects on significant polishing speed, low residue reduction after polishing, and stability.

In some embodiments, the additive is present in the polishing composition in an amount of more than 0.18 wt %, more than 0.19 wt %, more than 0.24 wt %, 0.25 wt % or more, 0.26 wt % or more, 0.28 wt % or more, 0.30 wt % or more, 0.32 wt % or more, or 0.34 wt % or more, based on the total weight of the polishing composition. Within this range, the significant polishing speed can be obtained.

3. pH-Adjusting Agent

The polishing compositions contain at least one pH-adjusting agent to control the pH. In some embodiments, the pH-adjusting agent may be acidic in nature. The choice of acid is not particularly limited, provided that the strength of the acid is sufficient to lower the pH of the polishing composition of the present invention.

The acidic pH-adjusting agent may be an inorganic or an organic acid. For example, and without limitation, such inorganic acids include: hydrochloric acid, sulfuric acid, nitric acid, boric acid, carbonic acid, hypophosphorous acid, phosphorous acid, and phosphoric acid. In some embodiments, the pH-adjusting agent is nitric acid.

For example, and without limitation, such organic acids include: formic acid, acetic acid, chloroacetic acid, propionic acid, butanoic acid, valeric acid, 2-methylbutyric acid, n-hexanoic acid, 3,3-dimethylbutanoic acid, 2-ethylbutanoic acid, 4-methylpentanoic acid, n-heptanoic acid, 2-methyl hexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citrate, citric acid, lactic acid, diglycolic acid, 2-furancarboxylic acid, 3-furancarboxylic acid, 2-tetrahydrofurancarboxylic acid, methoxyacetic acid, methoxyphenylacetic acid, and phenoxyacetic acid. Such organic acids also include, without limitation, organic sulfonic acid, such as: methanesulfonic acid, ethanesulfonic acid, and isethionic acid.

In alternate embodiments, the pH-adjusting agent may be a mixture of an acidic agent and basic agent (such as a buffer). In such embodiments, the choice of basic agent is not particularly limited, provided that the strength of the basic agent is sufficient to modulate the pH of the polishing composition of the present invention. For example, the basic agent can be an inorganic basic compound such as: an alkali metal hydroxide, an alkaline earth metal hydroxide, various carbonates, bicarbonates, and the like. Such basic compounds may be used singly or in combination of two or more types thereof.

Specific examples of the alkali metal hydroxide include: potassium hydroxide, sodium hydroxide, ammonium hydroxide, and the like. Specific examples of the carbonate and bicarbonate include: ammonium hydrogen carbonate, ammonium carbonate, potassium hydrogen carbonate, potassium carbonate, sodium hydrogen carbonate, sodium carbonate, and the like.

In an alternate embodiment, the pH-adjusting agent may be a buffer containing phosphates, acetates, borated, sulfonates, carboxylates, and the like.

The amount of pH adjusting agent can vary and is typically an amount sufficient to achieve and/or maintain the desired pH of the polishing composition, e.g., within the ranges set forth herein.

In an embodiment, the pH of the polishing composition is adjusted to a range that is from about 1.0 to about 3.0, from about 1.25 to about 2.80, from about 1.50 to about 2.75, from about 1.50 to about 2.50, from about 1.60 to about 2.40, from about 1.70 to about 2.30, from about 1.75 to about 2.25, from about 1.80 to about 2.20, from about 1.85 to about 2.15, or from about 1.90 to about 2.10.

In an embodiment, the pH of the polishing composition is adjusted to greater than about 1.0, greater than about 1.25, greater than about 1.50, greater than about 1.75, greater than about 1.85, greater than about 2.0, greater than about 2.25, greater than about 2.50, or greater than about 2.75, wherein the pH is no greater than about 3.0.

In some embodiments, the pH of the polishing composition is adjusted to about 3.00 or less, about 2.50 or less, about 2.25 or less, about 2.00 or less, about 1.75 or less, about 1.50 or less, or about 1.25 or less, wherein the pH is no less than about 1.00.

In some embodiments, the pH of the polishing composition is about 3.00, about 2.75, about 2.50, about 2.25, about 2.00, about 1.75, or about 1.50. In some embodiments, the pH of the polishing composition is less than 3. In some embodiments, the pH of the polishing composition is 2.9 or less, 2.7 or less, 2.5 or less, 2.3 or less, or 2.1 or less.

The pH-adjusting agent may be present at a specific concentration range, regardless of pH. For example, in some embodiments, the amount of pH-adjusting agent is in a range from about 0.0001 wt % to about 1.0 wt %, from about 0.001 wt % to about 1.0 wt %, from about 0.01 wt % to about 1.0 wt %, or from about 0.1 wt % to about 1.0 wt %. In alternate embodiments, the amount of pH adjusting agent is in a range from about 0.01 wt % to about 0.8 wt %, from about 0.01 wt % to about 0.6 wt %, from about 0.01 wt % to about 0.5 wt %, from about 0.01 wt % to about 0.2 wt %, or from about 0.01 wt % to about 0.1 wt %. In alternate embodiments, the amount of pH adjusting agent is in a range from about 0.01 wt % to about 0.75 wt %, from about 0.10 wt % to about 0.75 wt %, from about 0.25 wt % to about 0.75 wt %, or from about 0.50 wt % to about 0.75 wt %. In some embodiments, the amount of pH adjusting agent is present in an amount of at least about 0.0001 wt %, at least about 0.001 wt %, at least about 0.01 wt %, at least about 0.10 wt %, at least about 0.2 wt %, at least about 0.3 wt %, or at least about 0.4 wt %, but no greater than about 0.5 wt %. In some embodiments, the pH adjusting agent is present in an amount of less than about 0.75 wt %, less than about 0.65 wt %, less than about 0.50 wt %, less than about 0.25 wt %, less than about 0.10 wt %, or less than about 0.05 wt %, but no less than about 0.01 wt %. In some embodiments, the pH adjusting agent is present in an amount that is about 0.01 wt %, about 0.025 wt %, about 0.05 wt %, about 0.075 wt %, about 0.10 wt %, about 0.20 wt %, about 0.30 wt %, or about 0.40 wt %, but no more than about 0.50 wt %.

However, the polishing compositions preferably do not use too much pH-adjusting agent, as the amount of ions will have a negative effect on the selectivity ratio.

### 4. Water

In one embodiment, the polishing compositions disclosed herein contain a liquid carrier. In one embodiment, the liquid carrier is water. Ion-exchanged water (deionized water), pure water, ultrapure water, distilled water, and the like may be used as the water. In order to reduce the amount of unwanted components present in the water, the purity of water may be increased by operations such as: removal of impurity ions with an ion exchange resin, removal of contaminants with a filter, and/or distillation. In some embodiments, 80% by weight or more, 85% by weight or more, 90% by weight or more, 95% by weight or more, 98% by weight or more, or 99% by weight or more of the liquid carrier contained in the compositions is water (The upper limit is 100% by weight.).

In some embodiments, the water is relatively free of impurities. In some embodiments, the water contains less than about 10% w/w, about 9% w/w, about 8% w/w, about 7% w/w, about 6% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, or less than about 0.1% w/w of impurities based on the total weight of the water.

### 5. Additional Components

In an embodiment, the polishing compositions disclosed herein may contain additional components such as: oxidizers, polymers, chelating agent, biocides, surfactants, diluents, or co-solvents. Additionally or alternatively, the compositions disclosed herein can include other additives as will be understood by those skilled in the art.

In some embodiments, the additional component may include an oxidizer. Non-limiting examples of the oxidizer include: periodic acid, hydrogen peroxide, potassium iodate, potassium permanganate, persulfate salts (e.g., ammonium persulfate and potassium dipersulfate), periodate salts (e.g., potassium periodate), ammonium molybdate, ferric nitrate, nitric acid, potassium nitrate, and mixtures thereof. The amount of oxidizer may range from about 0.1 wt % to about 10.0 wt %, from about 0.25 wt % to about 3.0 wt %, or from about 0.5 wt % to about 1.5 wt %.

In an alternative embodiment, the polishing composition is oxidizer free. The term “oxidizer free” as used herein means that the polishing composition does not contain compounds known in the art to be used as oxidizer.

In one embodiment, the polymer is a polysaccharide such as pullulan. The pullulan is comprised of maltotriose units consisting of three α-1,4-linked glucose molecules are further linked by α-1,6-bonds. In an embodiment, pullulan has a weight average molecular weight ranging from 10,000 to 1,000,000. In some embodiments, the concentration of pullulan is present in the polishing composition in a range from about 0.01 wt % to about 0.05 wt %, such as about 0.02 wt %.

In an alternative embodiment, the polishing composition is polymer free. The term “polymer free” as used herein means that the polishing composition does not contain compounds known in the art as carbohydrates.

In an embodiment, the additional component may include a chelating agent. The term chelating agent is intended to mean any substance that, in the presence of an aqueous solution, chelates metals, such as copper. Non-limiting examples of chelating agents include, inorganic acids, organic acids, amines, and amino acids such as: glycine, alanine, citric acid, maleic acid, oxalic acid, malonic acid, phthalic acid, succinic acid, nitrilotriacetic acid, iminodiacetic acid, ethylenediaminetetraacetic acid (EDTA), diethylenetriamine pentaacetic acid (DTPA), triethylenetetraminehexaacetic acid (TTHA), hydroxyethylidenediphosphonic acid (HEDP), nitrilotris (methylenephosphonic acid) (NTMP), phosphonobutanetricarboxylic acid (PBTC), ethylenediaminetetra(methylenephosphonic acid) (EDTMP).

In an alternative embodiment, the polishing composition is chelating agent free. The term “chelating agent free” as used herein means that the polishing composition does not contain compounds known in the art as chelating agents. Non-limiting examples of chelating agents include compounds such as abovementioned.

In an embodiment, the additional component may be a biocide. Non-limiting examples of biocides include: quaternary ammonium compounds, and chlorine compounds. More specific examples of the quaternary ammonium compounds include, but are not limited to, methylisothiazolinone, tetramethylammonium chloride, tetraethylammonium chloride, tetrapropylammonium chloride, alkylbenzyldimethylammonium chloride, and alkylbenzyldimethylammonium hydroxide, wherein the alkyl chain ranges from 1 to about 20 carbon atoms. More specific examples of the chlorine compounds include, but are not limited to, sodium chlorite and sodium hypochlorite. Additional examples of biocides include: biguanide, aldehydes, ethylene oxide, isothiazolinone, iodophor, Kordek™ MLX from DuPont (which is an aqueous composition of 2-methyl-4-isothiazolin-3-one), KATHON™ and NEOLENE™ product families that are commercially available from Dow Chemicals, and the Preventol™ family from Lanxess. In an embodiment, the biocide is Kordek™ MLX. The amount of biocide used in the polishing composition may range from about 0.00005 wt % to 0.001 wt % or from about 0.0001 wt % to 0.0005 wt %. In some embodiments, the biocide is present in an amount about 0.0001 wt %, about 0.00013 wt %, or about 0.00015 wt %.

In another embodiment, the additional component may include a surfactant. The surfactants may be anionic, cationic, nonionic, or zwitterionic, and may increase lubricity of the vehicle or compositions. Non-limiting examples of the surfactants are: dodecyl sulfates, sodium salts or potassium salts, lauryl sulfates, secondary alkane sulfonates, alcohol ethoxylate, acetylenic diol surfactant, quaternary ammonium-based surfactants, amphoteric surfactants, such as betaines and amino acid derivatives-based surfactants, and any combination thereof. Examples of suitable commercially available surfactants include: TRITON™, TERGITOL™, and the DOWFAX™ family of surfactants manufactured by Dow Chemicals. Suitable surfactants of surfactants may also include polymers comprising ethylene oxide (EO) and propylene oxide (PO) groups. An example of EO-PO polymer is TETRONIC™ 90R4 from BASF Chemicals. The amount of surfactant used in the polishing composition may range from about 0.0005 wt % to 0.15 wt %, preferably from 0.001 wt % to 0.05 wt %, and more preferably from 0.0025 wt % to 0.025 wt %.

In another embodiment, the additional component may include another solvent, termed a co-solvent. Non-limiting examples of co-solvents include, but are not limited to: alcohol (such as methanol or ethanol), ethyl acetate, tetrahydrofuran, alkanes, dimethylformamide, toluene, ketones (such as acetone), aldehydes, and esters. Other non-limiting examples of co-solvents include dimethyl formamide, dimethyl sulfoxide, pyridine, acetonitrile, glycols, and mixtures thereof. The co-solvent may be employed in various amounts, preferably from a lower limit of about 0.0001, 0.001, 0.01, 0.1, 0.5, 1, 5, or 10% (wt %) to an upper limit of about 0.001, 0.01, 0.1, 1, 5, 10, 15, 20, 25, or 35% (wt %).

As described herein, the polishing compositions have specific properties, which are greatly influenced by the components in the composition, both in type and amount. Thus, certain materials may need to be excluded from the composition in order to maintain the desired properties.

The polishing slurries of the invention can be prepared by any suitable technique, many of which are known to those skilled in the art. The polishing composition can be prepared in a batch or a continuous process. Generally, the polishing composition can be prepared by combining the components disclosed herein in any order. The term “component” as used herein includes individual ingredients (e.g., abrasive, additive, and the like), as well as any combination of ingredients. For example, the abrasive can be dispersed in water, the additive, and any other additive material can be added and mixed by any method that is capable of incorporating the components into the polishing composition. The pH can be further adjusted, if desired, at any suitable time by addition of an acid or a buffer, as needed.

In some embodiments, the prepared polishing composition can be further diluted with a diluent. In some embodiments, the diluent is water. The amount of diluent added to the prepared polishing composition can vary. In some embodiments, the amount of diluent added to the polishing composition is at least about 1-fold, about 2-fold, about 3-fold, about 4-fold, about 5-fold, about 6-fold, about 7-fold, about 8-fold, about 9-fold, or about 10-fold, wherein each fold is based on the total volume of the polishing composition prior to dilution. In some embodiments, the amount of diluent added to the polishing composition is about 1-fold to about 10-fold, about 1-fold to about 8-fold, about 1-fold to about 6-fold, about 1-fold to about 4-fold, about 1-fold to about 3-fold, or about 2-fold, wherein each fold is based on the volume of the polishing composition prior to dilution. In some embodiments, the amount of diluent added to the polishing composition is about 2-fold to about 10-fold, about 4-fold to about 10-fold, about 6-fold to about 10-fold, or about 8-fold to about 10-fold, wherein each fold is based on the volume of the polishing composition prior to dilution. In some embodiments, the amount of diluent added to the polishing composition is about 2-fold to about 8-fold, about 4-fold to about 8-fold, about 6-fold to about 8-fold, about 2-fold to about 6-fold, or about 2-fold to about 4-fold, based on the volume of the polishing composition prior to dilution. In some embodiments, the amount of diluent added to the polishing composition is about 1-fold, about 2-fold, about 3-fold, about 4-fold, about 5-fold, about 6-fold, about 7-fold, about 8-fold, about 9-fold, or about 10-fold, based on the volume of the polishing composition prior to dilution.

Accordingly, the polishing compositions described herein have specific properties exemplified by their performance in SiON removal rate.

For the polishing compositions disclosed herein, the polishing compositions have a silicon oxynitride (SiON) removal rate of at least about 250 Å/min or greater, at least about 275 Å/min or greater, at least about 300 Å/min or greater, at least about 325 Å/min or greater, at least about 350 Å/min or greater, at least about 375 Å/min or greater, at least about 400 Å/min or greater, at least about 450 Å/min or greater, at least about 500 Å/min or greater, at least about 550 Å/min or greater, at least about 600 Å/min or greater, at least about 625 Å/min or greater, at least about 650 Å/min or greater, at least about 675 Å/min or greater, at least about 700 Å/min or greater, at least about 725 Å/min or greater, at least about 750 Å/min or greater, at least about 775 Å/min or greater, at least about 800 Å/min or greater, at least about 825 Å/min or greater, at least about 850 Å/min or greater, at least about 875 Å/min or greater, at least about 900 Å/min or greater, at least about 925 Å/min or greater, at least about 950 Å/min or greater, at least about 975 Å/min or greater, at least about 1000 Å/min or greater, at least about 1025 Å/min or greater, at least about 1050 Å/min or greater, at least about 1075 Å/min or greater, at least about 1100 Å/min or greater, at least about 1125 Å/min or greater, at least about 1150 Å/min or greater, at least about 1175 Å/min or greater, at least about 1200 Å/min or greater, at least about 1225 Å/min or greater, at least about 1250 Å/min or greater.

In some embodiments, the polishing compositions have a silicon oxynitride (SiON) removal rate ranging from about 250 Å/min to about 1,300 Å/min: from about 300 Å/min to about 1,275 Å/min: from about 300 Å/min to about 1,025 Å/min: from about 300 Å/min to about 1,000 Å/min: from about 300 Å/min to about 900 Å/min; from about 300 Å/min to about 875 Å/min: from about 300 Å/min to about 800 Å/min; from about 300 Å/min to about 755 Å/min: from about 300 Å/min to about 500 Å/min: from about 300 Å/min to about 400 Å/min; or from about 300 Å/min to about 325 Å/min.

In some embodiments, the polishing compositions have a silicon oxynitride (SiON) removal rate ranging from about 250 Å/min to about 1,260 Å/min: from about 250 Å/min to about 1,150 Å/min: from about 250 Å/min to about 1,025 Å/min: from about 250 Å/min to about 950 Å/min: from about 250 Å/min to about 850 Å/min; from about 250 Å/min to about 755 Å/min: from about 250 Å/min to about 500 Å/min: from about 250 Å/min to about 400 Å/min: or from about 250 Å/min to about 350 Å/min.

In some embodiments, the polishing compositions have a silicon oxynitride (SiON) removal rate ranging from about 300 Å/min to about 1,300 Å/min; from about 500 Å/min to about 1,300 Å/min: from about 700 Å/min to about 1,300 Å/min: from about 800 Å/min to about 1,300 Å/min; from about 850 Å/min to about 1,300 Å/min; from about 900 Å/min to about 1,300 Å/min: from about 950 Å/min to about 1,300 Å/min; from about 975 Å/min to about 1,300 Å/min: or from about 1,000 Å/min to about 1,300 Å/min.

Accordingly, as described herein, in some embodiments are polishing compositions comprising an abrasive, an additive, and water, wherein the abrasive is anionically modified colloidal silica, and the additive is an aminoalkyl alcohol, wherein the polishing composition has a pH of about <2.5.

As in any embodiment above, the polishing composition wherein the anionically modified colloidal silica has a mean particle size ranging from about 20 nm to about 70 nm.

As in any embodiment above, the polishing composition wherein the anionically modified colloidal silica has a mean particle size ranging from about 15 nm to 25 nm.

As in any embodiment above, the polishing composition wherein the anionically modified colloidal silica has a silanol density ranging from about 1 unit/nm⁻² to about 6.5 unit/nm⁻².

As in any embodiment above, the polishing composition wherein the colloidal silica has a silanol density ranging from about 5.8 unit/nm⁻² to about 6.2 unit/nm⁻².

As in any embodiment above, the polishing composition wherein the anionically modified colloidal silica is modified on its surface with anionic functional groups selected from the group consisting of sulfonic acid, carboxylic acid, and a combination thereof.

As in any embodiment above, the polishing composition wherein the abrasive is present in a concentration ranging from about 4 wt % to about 8 wt %.

As in any embodiment above, the polishing composition wherein the aminoalkyl alcohol is a (C6-C10) aminoalkyl alcohol.

As in any embodiment above, the polishing composition wherein the aminoalkyl alcohol has at least one hydroxyl group.

As in any embodiment above, the polishing composition wherein the aminoalkyl alcohol has a carbon atom-to-nitrogen or oxygen atom ratio that is >1.14.

As in any embodiment above, the polishing composition wherein the aminoalkyl alcohol has a carbon atom-to-nitrogen or oxygen atom ratio that is >4.

As in any embodiment above, a polishing composition wherein the aminoalkyl alcohol has a carbon atom-to-nitrogen atom ratio of from about 6:1 to about 10:1.

As in any embodiment above, a polishing composition wherein the aminoalkyl alcohol is selected from the group consisting of 3-amino-4-octanol, 2-amino-2-ethyl-1,3-propanediol, 2-diethyl ethanolamine, and 2-(octylamino)ethanol.

As in any embodiment above, a polishing composition wherein the aminoalkyl alcohol is present at a concentration of from about 0.20 wt % to about 0.40 wt %.

As in any embodiment above, a polishing composition wherein the pH range is in the range from about 2.0 to about 2.5.

As in any embodiment above, a polishing composition further comprising a pH-adjusting agent.

As in any embodiment above, a polishing composition wherein the pH-adjusting agent is an acid.

As in any embodiment above, a polishing composition wherein the pH-adjusting agent is nitric acid.

As in any embodiment above, a polishing composition wherein the polishing composition further comprising a pH-adjusting agent present in the amount ranging from about 0.01 wt % to about 0.5 wt %.

As in any embodiment above, a polishing composition wherein the polishing composition is stable for a period of at least one week. In an embodiment, the pH of the composition remains unchanged after a period of at least one week. In another embodiment, the electrical conductivity (EC) of the composition remains unchanged after a period of at least one week. In some embodiments, the electrical conductivity at POU (point of use; when customer uses) is from greater than zero to about 0.01 mS/cm, from greater than zero to about 0.05 mS/cm, from greater than zero to about 0.1 mS/cm, from greater than zero to about 0.3 mS/cm, from greater than zero to about 0.5 mS/cm, from greater than zero to about 0.75 mS/cm, or from greater than zero to about 1.0 mS/cm. In some embodiments, the electrical conductivity is from about 0.01 mS/cm to about 5.0 mS/cm, from about 0.5 mS/cm to about 3 mS/cm, or from about 1 mS/cm to about 2 mS/cm. In some embodiments, the electrical conductivity is about 0.02, 0.05, 0.10, 0.15, 0.2, 0.3, 0.5, 0.6, 0.7, 0.8, 0.9, 1.0, 1.5, 2.0, 2.5, 3.5, 3.0, or 4.5 mS/cm. In some embodiments, the upper limit of the electrical conductivity at POU is about 5 mS/cm, about 4 mS/cm, about 3 mS/cm, about 2 mS/cm, about 1 mS/cm.

In a further embodiment, the electrical conductivity is in the range from about 0.5 mS/cm to about 3.0 mS/cm.

Further, in some embodiments are a polishing composition comprising an abrasive, an additive, and water, wherein the abrasive is anionically modified colloidal silica present in a concentration ranging from about 4 wt % to about 8 wt %; and the additive is a (C6-C10) aminoalkyl alcohol present at a concentration of from about 0.20 wt % to about 0.40 wt %, wherein the polishing composition has a pH of about <2.5.

In additional embodiments are a polishing composition comprising an abrasive, an additive, and water, wherein the abrasive is anionically modified colloidal with a mean particle size ranging from about 20 nm to about 70 nm and a silanol density ranging from about 5.8 unit/nm⁻² to about 6.2 unit/nm⁻², and the additive is aminoalkyl alcohol is selected from the group consisting of 3-amino-4-octanol, 2-amino-2-ethyl-1,3-propanediol, 2-diethyl ethanolamine, and 2-(octylamino)ethanol, wherein the polishing composition has a pH ranging from about 2.0 to about 2.5.

As in any embodiment above, a polishing composition having a SiON removal rate ranging from about 250 Å/min to about 1300 Å/min.

As in any embodiment above, a polishing composition having a SiON removal rate ranging from about 850 Å/min to about 1300 Å/min.

As in any embodiment above, a polishing composition having a SiON removal rate ranging from about 250 Å/min to about 850 Å/min.

As in any embodiment above, a polishing composition wherein the pH-adjusting agent is present in the amount ranging from about 0.01 wt % to about 0.50 wt %.

### C. Methods of Using the Polishing Compositions

The polishing compositions described herein are useful for polishing any suitable substrate. In an embodiment, the substrate to be polished can be any suitable substrate, which comprises at least one layer of silicone oxynitride. Suitable substrates include, but are not limited to: anti-reflection coatings, multicrystalline solar cells, telecom devices, semiconductors, microelectromechanical systems, silicon-based photonics, and optoelectronics.

The subject matter disclosed herein also comprises a method for polishing a substrate with the polishing compositions described herein. The method of polishing a substrate comprises: (a) providing a substrate, (b) providing a polishing composition described herein, (c) applying the polishing composition to at least a portion of the substrate, and (d) abrading at least a portion of the substrate with the polishing composition to polish the substrate.

In the method of polishing a substrate, the method further comprises a step of diluting the polishing composition provided in step (b) with a diluent by at least about 1-fold, about 2-fold, about 3-fold, about 4-fold, about 5-fold, about 6-fold, about 7-fold, about 8-fold, about 9-fold, or about 10-fold, wherein each fold is based on the total volume of the polishing composition in step (b). In some embodiments, the polishing composition provided in step (b) is diluted by about 1-fold to about 10-fold, by about 1-fold to about 8-fold, by about 1-fold to about 6-fold, by about 1-fold to about 4-fold, by about 1-fold to about 3-fold, or by about 2-fold, wherein each fold is based on the total volume of the polishing composition in step (b). In some embodiments, the polishing composition provided in step (b) is diluted by about 2-fold to about 10-fold, by about 4-fold to about 10-fold, by about 6-fold to about 10-fold, or by about 8-fold to about 10-fold. In some embodiments, the polishing composition the polishing composition provided in step (b) is diluted by about 2-fold to about 8-fold, 4-fold to about 8-fold, 6-fold to about 8-fold, 2-fold to about 6-fold, 2-fold to about 4-fold, based on the total volume of the polishing composition in step (b). In some embodiments, the polishing composition provided in step (b) is diluted by about 1-fold, about 2-fold, about 3-fold, about 4-fold, about 5-fold, about 6-fold, about 7-fold, about 8-fold, about 9-fold, or about 10-fold, based on the total volume of the polishing composition in step (b). In some embodiments, the diluent is water.

In the method of polishing a substrate, the polishing compositions disclosed herein have a silicon oxynitride (SiON) removal rate of at least ≥about 250 Å/min: at least ≥about 275 Å/min: at least ≥about 300 Å/min: at least ≥about 325 Å/min: at least ≥about 350 Å/min; at least ≥about 375 Å/min: at least ≥about 400 Å/min: at least ≥about 450 Å/min: at least ≥about 500 Å/min: at least ≥about 550 Å/min: at least ≥about 600 Å/min; at least ≥about 625 Å/min: at least ≥about 650 Å/min: at least ≥about 675 Å/min: at least ≥about 700 Å/min: at least ≥about 725 Å/min: at least ≥about 750 Å/min: at least >about 775 Å/min; at least ≥about 800 Å/min: at least ≥about 825 Å/min: at least ≥about 850 Å/min: at least ≥about 875 Å/min; at least ≥about 900 Å/min; at least ≥about 925 Å/min: at least ≥about 950 Å/min: at least ≥about 975 Å/min: at least ≥about 1,000 Å/min: at least ≥about 1,025 Å/min: at least ≥about 1,050 Å/min; at least ≥about 1,075 Å/min: at least ≥about 1,100 Å/min: at least ≥about 1,125 Å/min: at least ≥about 1,150 Å/min; at least ≥about 1,175 Å/min: at least ≥about 1,200 Å/min: at least ≥about 1,225 Å/min: or at least ≥about 1,250 Å/min.

In the method of polishing a substrate, the polishing compositions disclosed herein have a silicon oxynitride (SiON) removal rate ranging from about 250 Å/min to about 1,300 Å/min: from about 300 Å/min to about 1,275 Å/min: from about 300 Å/min to about 1,025 Å/min: from about 300 Å/min to about 1,000 Å/min: from about 300 Å/min to about 900 Å/min: from about 300 Å/min to about 875 Å/min: from about 300 Å/min to about 800 Å/min: from about 300 Å/min to about 755 Å/min: from about 300 Å/min to about 500 Å/min: from about 300 Å/min to about 400 Å/min; or from about 300 Å/min to about 325 Å/min.

In the method of polishing a substrate, the polishing compositions disclosed herein have a silicon oxynitride (SiON) removal rate ranging from about 250 Å/min to about 1,260 Å/min: from about 250 Å/min to about 1,150 Å/min: from about 250 Å/min to about 1,025 Å/min; from about 250 Å/min to about 950 Å/min: from about 250 Å/min to about 850 Å/min: from about 250 Å/min to about 755 Å/min; from about 250 Å/min to about 500 Å/min: from about 250 Å/min to about 400 Å/min: or from about 250 Å/min to about 350 Å/min.

In the method of polishing a substrate, the polishing compositions disclosed herein have a silicon oxynitride (SiON) removal rate ranging from about 300 Å/min to about 1,300 Å/min: from about 500 Å/min to about 1,300 Å/min: from about 700 Å/min to about 1,300 Å/min: from about 800 Å/min to about 1,300 Å/min: from about 850 Å/min to about 1,300 Å/min; from about 900 Å/min to about 1,300 Å/min: from about 950 Å/min to about 1,300 Å/min: from about 975 Å/min to about 1,300 Å/min: or from about 1,000 Å/min to about 1,300 Å/min.

Accordingly, as described herein, in some embodiments are methods of using the polishing compositions, where the methods comprise the steps of: a) providing a substrate, wherein the substrate comprises a silicon oxynitride-containing layer; b) providing the polishing composition described herein; and c) polishing the substrate with the polishing composition to provide a polished substrate.

As in any embodiment above, a method wherein the substrate is a semiconductor.

As in any above embodiment above, a method further comprising a step of diluting the polishing composition of step (b) at least from about 1-fold to about 5-fold with a diluent.

As in any above embodiment above, a method wherein the diluent is water.

As in any embodiment above, a method wherein the SiON removal rate (RR) is at least ≥about 250 Å/min.

As in any embodiment above, a method wherein the SiON removal rate (RR) ranges from about 200 Å/min to about 1,300 Å/min.

As in any embodiment above, a method wherein the SiON removal rate (RR) ranges from about ≥about 250 Å/min to about 1,300 Å/min.

As in any embodiment above, a method wherein the SiON removal rate (RR) ranges from about ≥about 850 Å/min to about 1,300 Å/min.

As in any embodiment above, a method wherein the SiON removal rate (RR) ranges from about ≥about 250 Å/min to about 850 Å/min.

The present invention also encompasses the following aspect and form.

1. A polishing composition comprising: an abrasive; an additive; and water, wherein the abrasive comprises colloidal silica, the additive comprises an aminoalkyl alcohol, when the aminoalkyl alcohol is tertiary amine, a hydroxyl group-substituted alkyl group bonded to nitrogen atom is linear, and the polishing composition has a pH of about 2.5 or less.

2. The polishing composition according to 1., wherein the abrasive comprises anionically modified colloidal silica.

3. The polishing composition according to 1. or 2., wherein the colloidal silica has a silanol density of about 5.0/nm⁻² or more.

4. The polishing composition according to any one of 1. to 3., wherein the aminoalkyl alcohol is a (C5-C10) aminoalkyl alcohol.

5. The polishing composition according to any one of 1. to 4., wherein the aminoalkyl alcohol has a carbon atom to nitrogen or oxygen atom ratio of 1 to 12.

6. The polishing composition according to any one of 1. to 5., wherein the aminoalkyl alcohol is represented by N (R¹) (R²) (R³), and R¹, R², and R³ are each independently selected from hydrogen atom and the alkyl group optionally substituted with the hydroxyl group, i) at least one of R¹, R², and R³ is the alkyl group substituted with one or more hydroxyl groups, and ii) at least one of R¹, R², and R³ is an unsubstituted alkyl group, or at least two of R¹, R², and R³ are hydrogen atoms.

7. The polishing composition according to 6., wherein when the alkyl group substituted with the hydroxyl group comprises quaternary carbon, the alkyl group substituted with the hydroxyl group contains two or more hydroxyl groups.

8. The polishing composition of any of 1. to 7., wherein the abrasive comprises anionically modified colloidal silica present in a concentration ranging from about 4 wt % to about 8 wt %, and the additive comprises a (C6-C10) aminoalkyl alcohol present in a concentration of from about 0.20 wt % to about 0.40 wt %.

9. The polishing composition of any of 1. to 8., wherein the abrasive comprises anionically modified colloidal silica with a mean particle size ranging from about 20 nm to about 70 nm and a silanol density ranging from about 5.8/nm⁻² to about 6.2/nm⁻², and the additive comprises the aminoalkyl alcohol selected from the group consisting of 3-amino-4-octanol, 2-amino-2-ethyl-1,3-propanediol, 2-diethyl ethanolamine, and 2-(octylamino)ethanol.

10. The polishing composition according to 6. or 7., wherein the abrasive comprises anionically modified colloidal silica present in a concentration of about 3 wt % or more, and at least one of R¹, R², and R³ is the alkyl group having 6 or more carbon atoms which may be substituted with the hydroxyl group.

11. The polishing composition according to any one of 1. to 10., wherein the aminoalkyl alcohol is primary amine or secondary amine.

12. The polishing composition according to any one of 1. to 11., wherein the aminoalkyl alcohol does not contain a quaternary carbon.

13. The polishing composition according to any one of 1. to 12., wherein the aminoalkyl alcohol contains a secondary hydroxyl group.

### D. Examples

The following preparations and examples are given to enable those skilled in the art to more clearly understand and to practice the present invention. They should not be considered as limiting the scope of the invention, but merely as being illustrative and representative.

In one aspect, disclosed are methods of making the polishing compositions. In another aspect are disclosed methods of using the polishing compositions to polish materials.

### Example 1: Polishing Conditions

### Materials and Tools Used:

Polishing conditions
200 mm Polisher Westech
Platen rotation speed: 110 rpm
Head rotation speed: 104 rpm
Flow rate: 90 mL/min
Down force: 1.5 psi
Polishing time: 60 sec
Pad: medium hard pad
Dilution factor: 2x Instrumentation:
Westech (200 mm polisher),
Polishing pad: IC1010,
Pad conditioner: 3M A165

### Polishing Recipe

Down force: 1.5 psi
Rotation: 110/104 rpm
Slurry flow rate: 90 mL/min
Polishing time: 60 sec

### Example 2: Evaluation of Various Polishing Compositions and Additives

For this study, abrasive types A and B were investigated differing in their primary particle size, mean particle size and silanol (SiOH) density, which are summarized in Table 1 below: Both abrasive types A and B are sulfonic acid-immobilized colloidal silica.

TABLE A
Abrasive Information

| | Primary | Mean | SiOH |
|---|---|---|---|
| | Particle | Particle | Density[number/ |
| | Size[nm] | Size[nm] | nm²] |
| Abrasive-A | 35 | 70 | 5.2 |
| Abrasive-B | 12 | 21 | 5.8 |

In addition, a series of various additives were examined as well. Table B shows all of the additives used.

TABLE B
Additive Information

| Additive No. | Chemical Name | Chemical Structure |
|---|---|---|
| 1 | Potassium hydroxide | KOH |
| 2 | 2-diethyl ethanolamine | 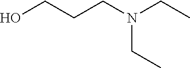 |
| 3 | 2-(octylamino)ethanol | 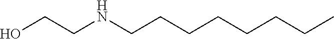 |
| 4 | 4-hydroxyl-benzene sulfonic acid | 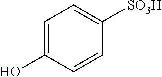 |
| 5 | 3-mercapto-1,2,4-triazole(3-MT) | 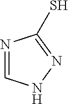 |
| 6 | 2-[[1,3-Dihydroxy-2-(hydroxymethyl)propan-2- yl]amino]ethane-1-sulfonic acid (TES) | 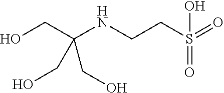 |
| 7 | N-cyclohexyl-3-aminopropanesulfonic acid (CAPS) | 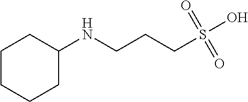 |
| 8 | 3-Morpholinopropane-1-sulfonic acid (MOPS) | 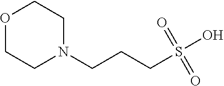 |
| 9 | N-(2-Acetamido)-2-aminoethanesulfonic acid (ACES) | 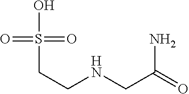 |
| 10 | 2-dimethylamino-2-methyl-1-propanol | 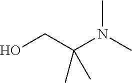 |
| 11 | 3-amino-4-octanol | 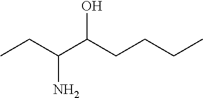 |
| 12 | 2-amino-2-ethyl-1,3-propanediol | 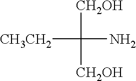 |

As is illustrated in Table 1, Slurries 1-11 were screened for suitable additives in polishing compositions containing abrasive type A at a concentration of 8 wt %, and a pH of 2 (using nitric acid as the pH-adjusting agent). The SiON removal rates (RR) were determined. Generally, slurries with a RR of 250 Å/min or greater were desirable. The data in Table 1 shows that Slurry-03 and Slurry-04 exhibited higher RR compared to other slurries (i.e., Slurries-02 and 05-11). In particular, Slurry-04 exhibited the highest SiON removal rate. Of note is that the strongly basic additive potassium hydroxide did not provide a desirable RR of 250 Å/min or greater, and essentially had no effect on RR compared to control Slurry-01.

Next, the effect of the type of abrasive was examined by comparing the SiON RR of Slurry-12 containing Abrasive B and Slurry-03 containing Abrasive A. As can be seen in Table 1 below, Slurry-12 exhibited a higher removal rate suggesting that Abrasive B enhances the SiON RR.

Lastly, the effects of pH were examined by comparing Slurry-14 with a pH of 2, Slurry-15 with a pH of 3, and Slurry-16 with a pH of 7. As can be seen in Table 1 below, a significant decrease in SiON RR was observed when the pH was increased from 2 to 3 (compare SiON RRs of Slurry-14 and Slurry-15). Furthermore, once the pH is greater than 2 the type of abrasive becomes negligible (compare SiON RRs of Slurry-15 and Slurry-13).

In summary, these results demonstrate that polishing compositions/slurries containing Abrasive B performs better than polishing compositions/slurry containing Abrasive A, provided that all other variables of the polishing composition/slurry remain the same (i.e., abrasive concentration, pH, pH-adjusting agent, additive, and amount of additive). The pH of the polishing composition/slurry can modulate the SION RR, i.e., increasing the pH results in a decrease of SION RR. Most importantly, the type of additive to be used determines the SION removal efficiency of the slurry. In Table 1, Slurry-03, Slurry-04, Slurry-12, and Slurry-14, with additives 2-diethyl ethanolamine, 2-(octylamino)ethanol, and 3-amino-4-octanol were identified as exhibiting the highest SiON RRs.

TABLE 1
Effect of additives on SiON removal rate

| | Abrasive | | | Additive | | | |
|---|---|---|---|---|---|---|---|
| | | conc. | pH-adjusting | | conc. | | SiON RR |
| Slurry No. | type | [wt %] | agent | type | [wt %]* | pH | (Å/min) |
| Slurry-01 | A | 8 | Nitric acid | — | — | 2 | 178 |
| Slurry-02 | A | 8 | Nitric acid | Potassium hydroxide | 0.1 | 2 | 181 |
| Slurry-03 | A | 8 | Nitric acid | 2-diethyl ethanolamine | 0.21 | 2 | 300 |
| Slurry-04 | A | 8 | Nitric acid | 2-(octylamino)ethanol | 0.31 | 2 | 900 |
| Slurry-05 | A | 8 | Nitric acid | 4-hydroxyl-benzene sulfonic acid | 0.26 | 2 | 219 |
| Slurry-06 | A | 8 | Nitric acid | 3-mercapto-1,2,4-triazole | 0.22 | 2 | 189 |
| Slurry-07 | A | 8 | Nitric acid | 2-{[1,3-Dihydroxy-2- | 0.50 | 2 | 116 |
| | | | | (hydroxymethyl)propan-2- | | | |
| | | | | yl]amino}ethane-1-sulfonic acid | | | |
| Slurry-08 | A | 8 | Nitric acid | N-cyclohexyl-3- | 0.48 | 2 | 80 |
| | | | | aminopropanesulfonic acid | | | |
| Slurry-09 | A | 8 | Nitric acid | 3-morpholinopropane-1-sulfonic acid | 0.45 | 2 | 117 |
| Slurry-10 | A | 8 | Nitric acid | N-(2-Acetamido)-2- | 0.39 | 2 | 145 |
| | | | | aminoethanesulfonic acid | | | |
| Slurry-11 | A | 8 | Nitric acid | 2-dimethylamino-2-methyl-1- | 0.19 | 2 | 212 |
| | | | | propanol | | | |
| Slurry-12 | B | 8 | Nitric acid | 2-diethyl ethanolamine | 0.21 | 2 | 320 |
| Slurry-13 | A | 8 | Nitric acid | 3-amino-4-octanol | 0.24 | 3 | 70 |
| Slurry-14 | B | 8 | Nitric acid | 3-amino-4-octanol | 0.24 | 2 | 996 |
| Slurry-15 | B | 8 | Nitric acid | 3-amino-4-octanol | 0.24 | 3 | 83 |
| Slurry-16 | B | 8 | Nitric acid | 3-amino-4-octanol | 0.24 | 7 | 41 |

*Concentrations adjusted for the same molarity of each compound.

Next, several slurries were prepared to investigate the effects the concentration of the additive and/or the concentration of the abrasive. As is illustrated in Table-2 below a general decrease in the efficiency of SiON removal can be observed when the amount of abrasive in the polishing composition is decreased. For example, Slurry-21, Slurry-22 and Slurry-23 demonstrate a steady decrease in the SiON RR as the abrasive concentration is lowered from 8 wt % to 4 wt % to 2 wt %, while keeping the amount of additive constant (i.e., 0.18 wt %). A similar decrease in the SiON RR was observed for Slurry-18, when the abrasive concentration was decreased from 8 wt % to 4 wt % (see Slurry-19) at a higher concentration of additive (i.e., 0.36 wt %).

With respect to the effects of additive concentration on the SiON RR, a steady decrease in SiON was observed when the additive concentration was decreased as well. For example, a steady decrease of the SiON RRs was observed for Slurry-18, Slurry-20, and Slurry-21 as the additive concentration decreased from 0.36 wt % to 0.24 wt % to 0.18 wt %, respectively. Lastly, Slurry-17 identified another additive suitable for the disclosed polishing compositions.

The results shown below in Table 2 demonstrate that the efficiency of SiON removal is dependent upon the concentration of the abrasive and/or the concentration of the additive.

TABLE 2
Effect of 3-amino-4-octanol concentration and abrasive concentration

| | Abrasive | | | Additive | | | |
|---|---|---|---|---|---|---|---|
| | | conc. | pH-adjusting | | conc. | | RR |
| Slurry No. | type | [wt %]] | agent | Type | [wt %]* | pH | Å/min |
| Slurry-17 | B | 8 | Nitric acid | 2-amino-2-ethyl-1,3-propanediol | 0.21 | 2 | 301 |
| Slurry-18 | B | 8 | Nitric acid | 3-amino-4-octanol | 0.36 | 2 | 1260 |
| Slurry-19 | B | 4 | Nitric acid | 3-amino-4-octanol | 0.36 | 2 | 1007 |
| Slurry-20 | B | 8 | Nitric acid | 3-amino-4-octanol | 0.24 | 2 | 996 |
| Slurry-21 | B | 8 | Nitric acid | 3-amino-4-octanol | 0.18 | 2 | 875 |
| Slurry-22 | B | 4 | Nitric acid | 3-amino-4-octanol | 0.18 | 2 | 754 |
| Slurry-23 | B | 2 | Nitric acid | 3-amino-4-octanol | 0.18 | 2 | 291 |

*Concentrations adjusted for the same molarity of each compound.

The carbon atom-to-nitrogen or oxygen atom ratio of the aminoalkyl alcohol is shown below.

TABLE 3
Carbon atom-to-nitrogen or oxygen
atom ratio of aminoalkyl alcohol

| Aminoalkyl alcohol | C | N | O | C/N | C/O |
|---|---|---|---|---|---|
| 2-diethyl ethanolamine | 7 | 1 | 1 | 7 | 7 |
| 2-(octylamino)ethanol | 10 | 1 | 1 | 10 | 10 |
| 2-dimethylamino-2-methyl-1-propanol | 6 | 1 | 1 | 6 | 6 |
| 3-amino-4-octanol | 8 | 1 | 1 | 8 | 8 |
| 2-amino-2-ethyl-1,3-propanediol | 5 | 1 | 2 | 5 | 2.5 |

According to some embodiments, at least one of C/N and C/O is 7 or more or 8 or more.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

This application is based on U.S. Provisional Patent Application No. 63/449,327, filed on Mar. 2, 2023, the disclosure of which is incorporated herein by reference in its entirety.

What is claimed is:

1. A polishing composition comprising:
an abrasive; an additive; and water, wherein
the abrasive comprises colloidal silica,
the additive comprises an aminoalkyl alcohol, wherein when the aminoalkyl alcohol is tertiary amine, a hydroxyl group-substituted alkyl group bonded to nitrogen atom is linear, and
the polishing composition has a pH of about 2.5 or less.

2. The polishing composition according to claim 1, wherein the abrasive comprises anionically modified colloidal silica.

3. The polishing composition according to claim 1, wherein the colloidal silica has a silanol density of about 5.0/nm⁻² or more.

4. The polishing composition according to claim 1, wherein the aminoalkyl alcohol is a (C5-C10) aminoalkyl alcohol.

5. The polishing composition according to claim 1, wherein the aminoalkyl alcohol has a carbon atom to nitrogen or oxygen atom ratio of 1 to 12.

6. The polishing composition according to claim 1, wherein
the aminoalkyl alcohol is represented by N (R¹) (R²) (R³), and R¹, R², and R³ are each independently selected from hydrogen atom and the alkyl group optionally substituted with the hydroxyl group,
i) at least one of R¹, R², and R³ is the alkyl group substituted with one or more hydroxyl groups, and
ii) at least one of R¹, R², and R³ is an unsubstituted alkyl group, or at least two of R¹, R², and R³ are hydrogen atoms.

7. The polishing composition according to claim 6, wherein when the alkyl group substituted with the hydroxyl group comprises quaternary carbon, the alkyl group substituted with the hydroxyl group contains two or more hydroxyl groups.

8. The polishing composition according to claim 1, wherein
the abrasive comprises anionically modified colloidal silica present in a concentration ranging from about 4 wt % to about 8 wt %, and
the additive comprises a (C6-C10) aminoalkyl alcohol present in a concentration of from about 0.20 wt % to about 0.40 wt %.

9. The polishing composition according to claim 1, wherein the abrasive comprises anionically modified colloidal silica with a mean particle size ranging from about 20 nm to about 70 nm and a silanol density ranging from about 5.8/nm⁻² to about 6.2/nm⁻², and
the additive comprises the aminoalkyl alcohol selected from the group consisting of 3-amino-4-octanol, 2-amino-2-ethyl-1,3-propanediol, 2-diethyl ethanolamine, and 2-(octylamino)ethanol.

10. The polishing composition according to claim 6, wherein the abrasive comprises anionically modified colloidal silica present in a concentration of about 3 wt % or more, and
at least one of R¹, R², and R³ is the alkyl group having 6 or more carbon atoms which may be substituted with the hydroxyl group.

11. The polishing composition according to claim 1, wherein the aminoalkyl alcohol is primary amine or secondary amine.

12. The polishing composition according to claim 11, wherein the aminoalkyl alcohol does not contain a quaternary carbon.

13. The polishing composition according to claim 1, wherein the aminoalkyl alcohol contains a secondary hydroxyl group.
